(19) United States
(12) Patent Application Publication
(10) Pub. No.: US 2026/0039395 A1
(43) Pub. Date: Feb. 5, 2026

(54) Methods and Apparatus for Optical Beam Compensation in a Satellite Communications System

(71) Applicant: Viasat Inc., Carlsbad, CA (US)

(72) Inventor: Hamid Hemmati, Los Angeles, CA (US)

(21) Appl. No.: 18/997,926

(22) PCT Filed: Jul. 18, 2023
(86) PCT No.: PCT/US2023/028068

§ 371 Date: Jan. 23, 2025

Related U.S. Application Data
(60) Provisional application No. 63/392,107, filed on Jul. 25, 2022.

(51) Int. Cl. H04B 10/67; H04B 10/118; H04B 10/40; H04B 10/50

(52) U.S. Cl. CPC H04B 10/67; H04B 10/118; H04B 10/40; H04B 10/503

(57) ABSTRACT

Techniques disclosed herein relate to compensation of optical beams—laser beams—in satellite communications systems. based on the use of a beacon satellite to redirect an optical downlink reference beam from a communications satellite. for reception by a terrestrial terminal. The beacon satellite flies ahead of the communications satellite on the same orbital path by a distance corresponding to the point ahead angle (PAA) used by the terrestrial terminal for transmission of an optical uplink communications beam. Thus, the optical downlink reference beam provides a direct basis for the terrestrial terminal to detect wavefront distortions associated with the atmospheric path traversed by the optical uplink communications beam.

### TECHNICAL FIELD

Techniques disclosed herein relate to compensation of atmospheric effects on optical uplink beams of a satellite communications system.

### BACKGROUND

FIG. 1 illustrates a typical satellite communications system 10, including a terrestrial terminal 12 that receives an optical downlink communications beam 14 from a communications satellite 16 traveling along a defined orbital path 18. Because of the movement of the satellite 16 relative to the terrestrial terminal 12, the terrestrial terminal 12 transmits an optical uplink communications beam 20 for the communications satellite 16 using a point ahead angle (PAA).

The need for the PAA arises due to the cross velocity between the satellite 16 and the Earth. As a signal travels from the terrestrial terminal 12 to the satellite 16, the satellite moves along its orbital path 18. To ensure that the optical uplink communications beam 20 reaches the satellite 16, the terrestrial terminal 12 must aim slightly ahead of the current position of the satellite 16, anticipating where the satellite will be when the optical uplink communications beam arrives. The PAA is the angle between the line of sight and the future position. Using annotations in the diagram, the PAA accounts for the movement of the satellite 16 along the orbital path 18 from time t0 to time t1.

For example, the point-ahead-angle to a GEO satellite is approximately 18.5 micro-radian. A GEO satellite moves approximately 800 meters during the time of flight of uplink and downlink. One consequence of the PAA is that the atmospheric path traversed by the optical downlink communications beam 14 is not a good representation of the atmospheric path traversed by the optical uplink communications beam 20. This fact limits the ability of the terrestrial terminal 12 to use the optical downlink communications beam 14 as a reference for determining compensations to apply to the optical uplink communications beam 20. Here, the desired compensations for the optical uplink communications beam mitigate the wavefront distortions imparted to the optical uplink communications beam by atmospheric turbulence in the near field of the terrestrial terminal 12.

In an ideal case, the terrestrial terminal 12 has a good estimate of the wavefront distortions that will be imparted by the atmosphere to its optical uplink communications beam 20. Correspondingly, by applying inverse wavefront distortions-predistortions-when transmitting the optical uplink communications beam 20, the terrestrial terminal 12 mitigates the atmospheric distortions.

One approach to estimating the uplink atmospheric path more accurately relies on the transmission by the terrestrial terminal 12 of an excitation beam in the point ahead direction, to create an “artificial star”. The star results from excitation by a laser beam focused on the Sodium atoms in the mesosphere layer, with the terrestrial terminal then evaluating the dim light returned from the artificial star, for estimation of the uplink path. However, the artificial star approach has several shortcomings in the context of free-space optical communications, such as the requirement for the transmission of a relatively high-power laser from the terrestrial terminal dedicated to both daytime and night-time links and substantially dimmer returned Sodium florescence signal levels dominated by background light during daytime.

### SUMMARY

Techniques disclosed herein relate to compensation of uplink optical communications beams—laser beams—in satellite communications systems, based on the use of a beacon satellite to redirect an optical downlink reference beam from a communications satellite, for reception by a terrestrial terminal. With the beacon satellite flying ahead of the communications satellite on the same orbital path by a distance corresponding to the point-ahead angle (PAA) used by the terrestrial terminal for transmission of an optical uplink communications beam, the optical downlink reference beam provides a direct basis for the terrestrial terminal to detect wavefront distortions associated with the atmospheric path traversed by the optical uplink communications beam.

An example embodiment comprises a method of operation by a terrestrial terminal of a satellite communications system. The method includes receiving an optical downlink communications beam transmitted by a communications satellite towards the terrestrial terminal and simultaneously receiving an optical downlink reference beam that is transmitted by the communications satellite towards a beacon satellite. The beacon satellite leads the communications satellite by a defined distance along a same orbital path, with the beacon satellite redirecting the optical downlink reference beam towards the terrestrial terminal. Further, the method includes the terrestrial terminal controlling wavefront predistortion of an optical uplink communications beam transmitted by the terrestrial terminal for the communications satellite, as a function of wavefront distortions detected in the optical downlink reference beam.

A related embodiment comprises a terrestrial terminal of a satellite communications system. The terrestrial terminal includes one or more optical receivers and an optical transmitter. One or more optical receivers are configured to receive an optical downlink communications beam transmitted by a communications satellite towards the terrestrial terminal and simultaneously receive an optical downlink reference beam. The communications satellite transmits the optical downlink reference beam towards a beacon satellite that leads the communications satellite by a defined distance along a same orbital path, with the beacon satellite redirecting the optical downlink reference beam towards the terrestrial terminal. The optical transmitter of the terrestrial terminal is configured to control wavefront predistortion of an optical uplink communications beam transmitted for the communications satellite, as a function of wavefront distortions detected in the optical downlink reference beam.

Another embodiment comprises a method of operation by a beacon satellite and a communications satellite of a satellite communications system. The method includes the communications satellite transmitting an optical downlink communications beam towards a terrestrial terminal and simultaneously transmitting an optical downlink reference beam towards the beacon satellite, which flies in formation with the communication satellite along a same orbital path by a defined distance that depends on the orbit of the communications satellite as the mothership satellite. The method further includes the beacon satellite, operating as a much smaller passive daughter satellite, redirecting the optical downlink reference beam emanated from the communication satellite towards the terrestrial terminal. The terrestrial terminal then uses this re-directed and downlinked signal in determining wavefront predistortions applied by the terrestrial terminal to an optical uplink communications beam transmitted by the terrestrial terminal for the communications satellite.

In at least one embodiment, the method further includes, at the terrestrial terminal, receiving the optical downlink communications beam and the optical downlink reference beam, and controlling wavefront predistortion of an optical uplink communications beam transmitted by the terrestrial terminal for the communications satellite, as a function of wavefront distortions detected in the optical downlink reference beam. For example, the terrestrial terminal includes a deformable mirror or other adaptive optics for controlling the wavefront predistortion.

In another example embodiment, a satellite communications system includes a communications satellite and a beacon satellite. The communications satellite is configured to transmit an optical downlink communications beam towards a terrestrial terminal and simultaneously transmit an optical downlink reference beam towards the beacon satellite when the beacon satellite is flying ahead of the communication satellite along a same orbital path by a defined distance. The beacon satellite is configured to redirect the optical downlink reference beam from the beacon satellite towards the terrestrial terminal, for use by the terrestrial terminal in determining wavefront predistortions applied by the terrestrial terminal to an optical uplink communications beam transmitted by the terrestrial terminal for the communications satellite.

The satellite communications system may further comprise the terrestrial terminal, where, in one or more embodiments, the terrestrial terminal is configured to: (a) receive the optical downlink communications beam and the optical downlink reference beam at the terrestrial terminal, and (b) control wavefront predistortion of an optical uplink communications beam transmitted by the terrestrial terminal for the communications satellite, as a function of wavefront distortions detected in the optical downlink reference beam.

Of course, the present invention is not limited to the above features and advantages. Indeed, those skilled in the art will recognize additional features and advantages upon reading the following detailed description, and upon viewing the accompanying drawings.

### BRIEF DESCRIPTION OF THE DRAWINGS

FIG. 1 is a block diagram of a known satellite communications system.

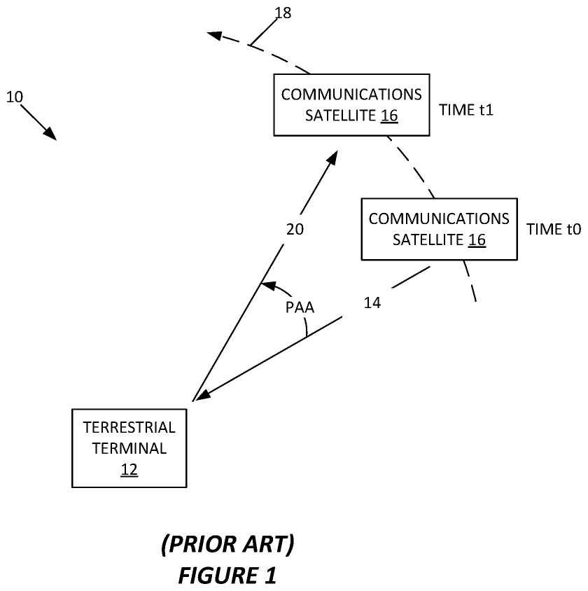

FIG. 2 is a block diagram of a satellite communications system, according to an example embodiment.

FIG. 3 is a block diagram of details for implementation of a terrestrial terminal of a satellite communications system, according to an example embodiment.

FIG. 4 is a block diagram of further details for a terrestrial terminal, according to an example embodiment.

FIG. 5 is a logic flow diagram of a method of operation by a terrestrial terminal of a satellite communications system, according to an example embodiment.

FIG. 6 is a logic flow diagram of a method of operation by a communications satellite and a companion beacon satellite of a satellite communications system, according to an example embodiment.

### DETAILED DESCRIPTION

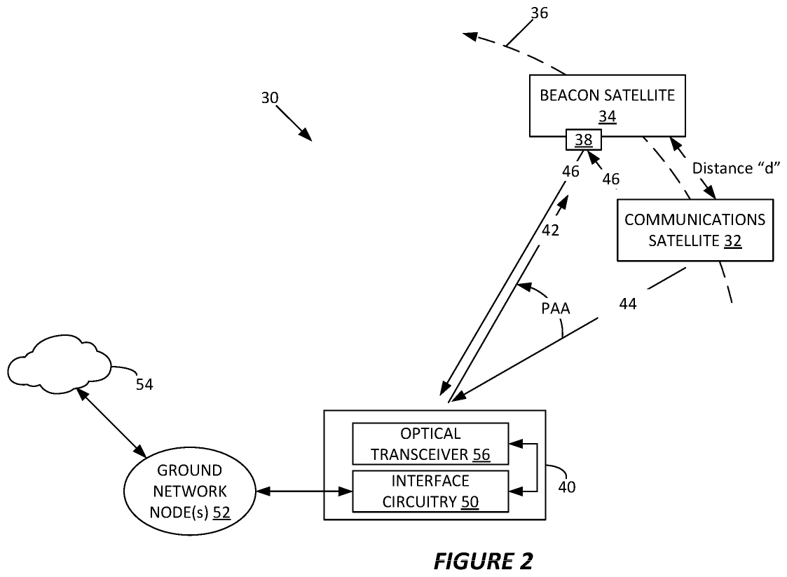

FIG. 2 illustrates an example satellite communications system 30 according to one embodiment. The satellite communications system 30 includes a communications satellite 32 and a beacon satellite 34. In operation, the beacon satellite 34 flies a defined distance “d” ahead of the communications satellite 32, along the same orbital path 36 followed by the communications satellite 32. The defined distance d accounts for the velocity and altitude of the communications satellite 32 and corresponds with the point ahead angle (PAA) used by a terrestrial terminal 40, for transmission of an optical uplink communications beam 42. Here, and elsewhere in this disclosure, the term “optical beam” means laser beam, where an “optical communications beam” refers to a laser beam carrying communications data—e.g., user traffic.

The communications satellite 32 is configured to transmit an optical downlink communications beam 44, for direct reception by the terrestrial terminal 40, with the terrestrial terminal 40 being configured to transmit the optical uplink communications beam 42 for direct reception by the communications satellite 32. Because FIG. 2 represents a single time instant, it will be appreciated that the communications satellite 32 will have moved to the position occupied by the beacon satellite 34 during the time it takes the optical uplink communications beam 42 to travel to the communications satellite 32.

According to the above arrangement, the communications satellite 32 and the beacon satellite 34 cooperate to provide the terrestrial terminal 40 with an optical downlink reference beam 46 that travels a downlink path corresponding to the uplink path of the optical uplink communications beam 42. In particular, the optical downlink reference beam 46 accounts for the PAA used by the terrestrial terminal 40.

To achieve this relationship, the communications satellite 32 is configured to transmit the optical downlink reference beam 46 towards the terrestrial terminal 40, simultaneously with transmission of the optical downlink communications beam 44 towards the beacon satellite 34. with the beacon satellite 34 being configured to redirect the optical downlink reference beam 46 towards the terrestrial terminal 40. In one or more embodiments, redirection of the optical downlink communications beam 44 relies on a passive redirection element 38 onboard the beacon satellite 34. Example passive redirection elements include a reflective cone, mirror combinations, prism-like passive optics, or another passive optical redirection means. In one or more embodiments, the passive redirection element 38 is steerable, for pointing adjustments.

In the illustrated embodiment, the terrestrial terminal 40 includes interface circuitry 50 configured for receiving traffic and control signaling from one or more ground network nodes 52 of the satellite communications system 30, for transmission to the communications satellite 32 via the optical uplink communications beam 42. Further, the interface circuitry 50 is configured for transmitting traffic and control signaling received from the communications satellite 32 via the optical downlink communications beam 44. Such traffic may be associated with user traffic incoming from and outgoing to one or more external networks 54, such as the Internet.

The interface circuitry 50 comprises physical layer circuitry for wired or wireless transmission and reception on the medium used for interconnecting the terrestrial terminal 40 with the ground network node(s) 52. In at least one embodiment, the interface circuitry 50 comprises data network interface circuitry and associated protocol processors. Further elements of the terrestrial terminal 40 include an optical transceiver 56, which is communicatively coupled locally with the interface circuitry 50, for receiving traffic and control signaling to be transmitted via the optical uplink communications beam 42, and for recovering traffic and control signaling incoming on the optical downlink communications beam 44 and transferring such information to the ground network node(s) 52.

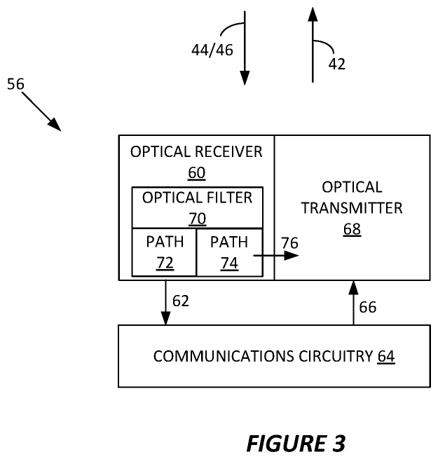

The optical transceiver 56 includes one or more optical receivers and an optical transmitter, with FIG. 3 illustrating an example arrangement including an optical receiver 60 that outputs a received signal 62, e.g., in the electrical domain, corresponding to information conveyed via the optical downlink communications beam 44. Communications circuitry 64, which may be included in the interface circuitry 50 shown in FIG. 2, processes the received signal 62 for coupling back to the ground network node(s) 52 via the interface circuitry 50.

The communications circuitry 64 also outputs a transmit signal 66, e.g., in the electrical domain, with the transmit signal carrying data for transmission by the communications satellite 32. An optical transmitter 68 forms the optical uplink communications beam 42 responsive to the transmit signal 66, such as by modulating a source laser beam according to the transmit signal 66.

In one or more embodiments, the optical downlink communications beam 44 and the optical downlink reference beam 46 are at different wavelengths, and the optical receiver 60 includes an optical filter 70 or other optical discriminator, for separation of the two beams into respective optical paths 72 and 74. The optical path 72 is associated with reception of the optical downlink communications beam 44, and the optical path 74 is associated with use of the optical downlink reference beam 46 for determination of predistortion to apply in transmission of the optical uplink communications beam 42. Correspondingly, the reference number “76” in FIG. 3 suggests the internal routing or directing of the received optical downlink reference beam 46, for use in determining predistortions to the optical uplink communications beam 42.

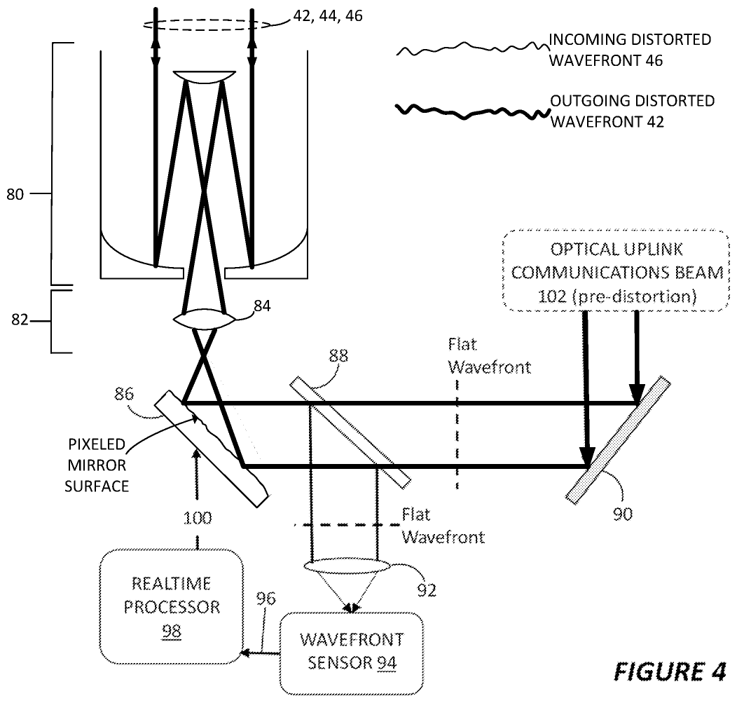

FIG. 4 illustrates selected details, focused on use of the optical downlink reference beam 46 for use in determining predistortions to apply in transmission of the optical uplink communications beam 42, for mitigation of atmospheric effects.

An optical head assembly 80 and associated optical telescope 82 provide for beam reception and transmission. The telescope 82 includes a lens 84, with further optical elements including a deformable mirror 86, and a dichromic beam splitter 88 as an example of the optical filter 70 shown in FIG. 3. Further included among the optical elements are a point-ahead mirror 90 and a lens 92.

In operation, the dichromic beam splitter 88 directs the received optical downlink reference beam 46 onto the lens 92, for illumination of a wavefront sensor 94. The wavefront sensor 94 outputs a signal 96 to a real-time processor 98 indicative of detected wavefront distortions in the received optical downlink reference beam 46. These distortions arise from turbulence and other atmospheric effects experienced by the optical downlink reference beam 46 along the atmospheric path transited by the optical downlink reference beam 46.

The real-time processor 98 generates control signals 100 for controlling the deformable mirror 86, such that it imparts predistortions to an outgoing optical uplink communications beam 102. The outgoing optical uplink communications beam 102 is the pre-distorted version of the optical uplink communications beam 42 and the applied predistortions are inverse with respect to the distortions detected by the wavefront sensor 94. As such, the deformable mirror 86 may be understood as one example of adaptive optics used by the terrestrial terminal 40 for transmitting the optical uplink communications beam 42 with wavefront predistortions that mitigate the atmospheric effects of the atmospheric path transited by the optical uplink communications beam 42.

The real-time processor 98 comprises fixed circuitry or programmatically configured circuitry or a mix of both. In one or more embodiments, the real-time processor 98 comprises digital processing circuitry including any one or more of: one or more microprocessors, one or more digital signal processors, one or more field programmable gate arrays, one or more complex programmable logic devices, or one or more application specific integrated circuits. In at least one embodiment, all, or a portion of the real-time processor 98 comprises digital processing circuitry that is specially adapted to control the deformable mirror 86 responsive to the wavefront distortions detected via the wavefront sensor 94, based on the execution of stored computer program instructions.

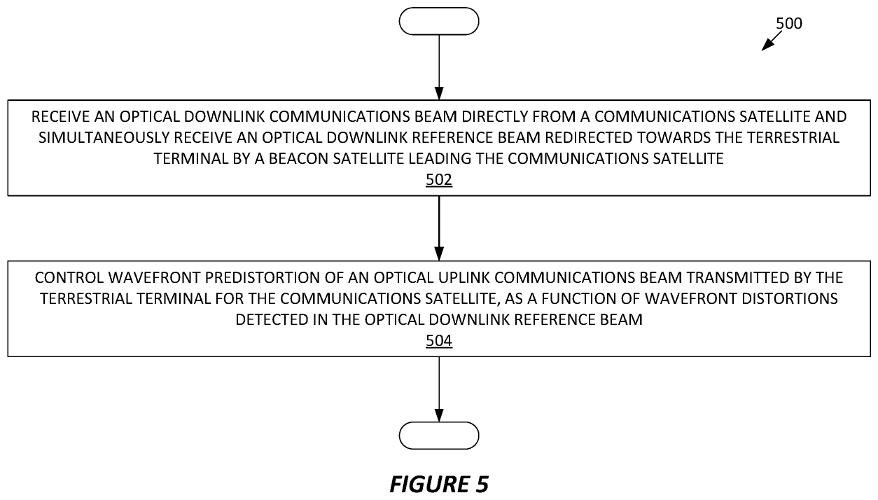

FIG. 5 illustrates a method 500 of operation by a terrestrial terminal 40 of a satellite communications system 30. The method 500 includes the terrestrial terminal 40 receiving (Block 502) an optical downlink communications beam 44 transmitted by a communications satellite 32 towards the terrestrial terminal 40 and simultaneously receiving an optical downlink reference beam 46 that is transmitted by the communications satellite 32 towards a beacon satellite 34 that leads the communications satellite 32 by a defined distance along a same orbital path 36. The beacon satellite 34 redirects the optical downlink reference beam 46 towards the terrestrial terminal 40.

Further, the method 500 includes the terrestrial terminal 40 controlling (Block 504) wavefront predistortion of an optical uplink communications beam 42 transmitted by the terrestrial terminal 40 for the communications satellite 32, as a function of wavefront distortions detected in the optical downlink reference beam 46. In at least one embodiment, controlling the wavefront predistortion of the optical uplink communications beam 42 includes, on an ongoing basis, detecting the wavefront distortions of the optical downlink reference beam 46 via a wavefront distortion detector 84, determining complementary wavefront predistortions for application to the optical uplink communications beam 42, and applying the complementary wavefront predistortions to the optical uplink communications beam 42 via adaptive optics in an optical transmitter 68 of the terrestrial terminal 40. The adaptive optics include, for example, a deformable mirror 86.

In one or more embodiments, the method 500 includes the terrestrial terminal 40 receiving the optical downlink communications beam 44 and the optical downlink reference beam 46 via a same optical receiver 60 of the terrestrial terminal 40. The optical receiver 60 in at least one such embodiment includes a first optical path 72 for processing the optical downlink communications beam 44 and a second optical path 74 for directing the optical downlink reference beam 46 for detection of wavefront distortions.

The optical downlink communications beam 44 and the optical downlink reference beam 46 are at different wavelengths in one or more embodiments, such that the method 500 includes the terrestrial terminal 40 performing wavelength-based filtering to direct the optical downlink communications beam 44 into the first optical path 72 and direct the optical downlink reference beam 46 into the second optical path 74. In one or more other embodiments, the method 500 includes the terrestrial terminal 40 distinguishing the optical downlink reference beam 46 from the optical downlink communications beam 44, based on the optical downlink reference beam 46 being modulated at a specific rate.

One advantage of the various arrangements shown by way of example herein is that the defined distance by which the beacon satellite 34 leads the communications satellite 32 corresponds with a PAA used by the terrestrial terminal 40 for transmission of the optical uplink communications beam 42. Thus, the wavefront distortions detected in the optical downlink reference beam 46 correspond to the atmospheric path defined by the PAA. That is, the optical downlink reference beam 46 and the optical uplink reference beam 42 transmit substantially the same atmospheric path. Consequently, the terrestrial terminal 40 may, on an ongoing basis, detect wavefront distortions in the optical downlink reference beam 46 during reception of that beam and apply corresponding inverse distortions to the outgoing optical uplink communications beam 42.

Another advantage is that the beacon satellite 34 need not be complex. Apart from basic telemetry and guidance capabilities, it need have nothing more than a passive redirection element 38 mounted on it, for redirection of the optical downlink reference beam 46 from the communications satellite 32 towards the terrestrial terminal 40. As noted, the passive redirection element 38 may be a mirror for reflective redirection. Other alternatives include prismatic elements or lenses, for transmissive redirection.

In one or more embodiments, the terrestrial terminal 40 is a satellite access node (SAN) of the satellite communications system 30. Such an embodiment is shown in FIG. 2. Correspondingly, in such embodiments, the optical downlink communications beam 44 is an optical feeder downlink signal, and the optical uplink communications beam 42 is an optical feeder uplink signal. The terms “optical ground station” and “OGS” may be used interchangeably with satellite access node or SAN.

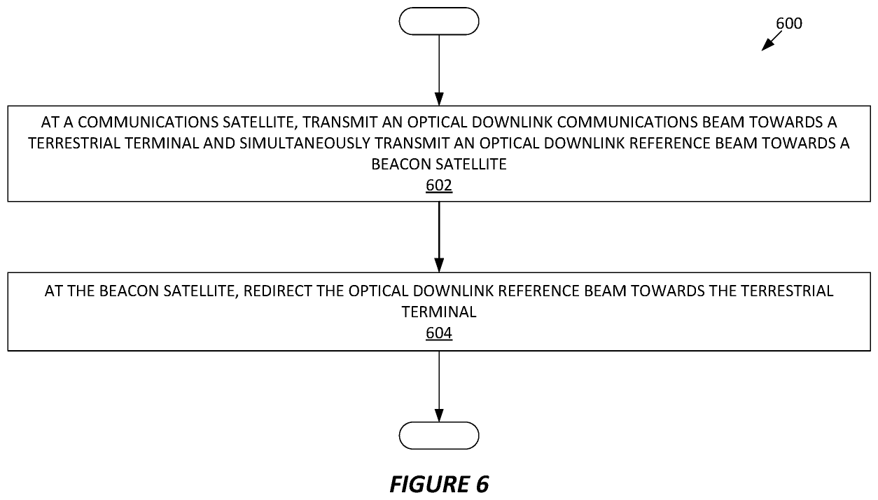

FIG. 6 illustrates a method 600 of operation by a satellite communications system 30 comprising a beacon satellite 34 and a communications satellite 32. The method 600 includes transmitting (Block 602) an optical downlink communications beam 44 from the communications satellite 32 towards a terrestrial terminal 40 and simultaneously transmitting an optical downlink reference beam 46 towards the beacon satellite 34. In operation, the beacon satellite 34 flies ahead of the communication satellite 32 along a same orbital path 36 by a defined distance. The defined distance corresponds to the PAA used by the terrestrial terminal 40 for transmitting an optical uplink communications beam 42 for reception by the communications satellite 32.

The method 600 further includes redirecting (Block 604) the optical downlink reference beam 46 from the beacon satellite 34 towards the terrestrial terminal 40. Redirection is based on, for example, use of a simple optical redirection element 38 onboard the beacon satellite 34. Redirection of the optical downlink reference beam 46 is for use by the terrestrial terminal 40 in determining wavefront predistortions applied by the terrestrial terminal 40 to the optical uplink communications beam 42 transmitted by the terrestrial terminal 40 for the communications satellite 32.

The method 600 in one or more embodiments includes controlling the communications satellite 32 and/or the beacon satellite 34 to maintain the beacon satellite 34 at the defined distance from the communications satellite 32. Control may be based on the transmission of control signals to the beacon satellite 34 from the ground. Alternatively, the terrestrial terminal 40 and/or other ground nodes of the satellite communications system 30 is/are configured to transmit control signals to the communications satellite 32, which then transmits to the beacon satellite 34 via an inter-satellite link.

In one or more embodiments, the method 600 may be considered to include the operations depicted for the method 500. That is, the method 600 may include operations at the terrestrial terminal 40, including (a) receiving the optical downlink communications beam 44 from the communications satellite 32 and the optical downlink reference beam 46 as redirected by beacon satellite 34, and (b) controlling wavefront predistortion of an optical uplink communications beam 42 transmitted by the terrestrial terminal 40 for the communications satellite 32, as a function of wavefront distortions detected in the optical downlink reference beam 46.

Controlling the wavefront predistortion comprises, on an ongoing basis, the terrestrial terminal 40 detecting the wavefront distortions of the optical downlink reference beam 46 via a wavefront distortion detector 84, for example, and determining complementary wavefront predistortions for application to the optical uplink communications beam 42. These complementary—inverse—wavefront predistortions are applied via adaptive optics, for example.

Broadly, according to the disclosed techniques, a beacon satellite flies in formation with a main communications satellite and, in one or more embodiments, is passive and equipped only with optics to re-direct a beacon beam from the communications satellite. This arrangement has several advantages, including not requiring the beacon satellite, also referred to as a “daughter” or “companion” satellite, to carry an active beacon laser, which reduces power supply requirements.

Notably, modifications and other embodiments of the disclosed invention(s) will come to mind to one skilled in the art having the benefit of the teachings presented in the foregoing descriptions and the associated drawings. Therefore, it is to be understood that the invention(s) is/are not to be limited to the specific embodiments disclosed and that modifications and other embodiments are intended to be included within the scope of this disclosure. Although specific terms may be employed herein, they are used in a generic and descriptive sense only and not for purposes of limitation.

1-43. (canceled)

44. A terrestrial terminal of a satellite communications system, the terrestrial terminal comprising:
one or more optical receivers configured to receive an optical downlink communications beam transmitted by a communications satellite towards the terrestrial terminal and simultaneously receive an optical downlink reference beam that is transmitted by the communications satellite towards a beacon satellite leading the communications satellite by a defined distance along a same orbital path, with the beacon satellite redirecting the optical downlink reference beam towards the terrestrial terminal; and
an optical transmitter configured to control wavefront predistortion of an optical uplink communications beam transmitted for the communications satellite, as a function of wavefront distortions detected in the optical downlink reference beam.

45. The terrestrial terminal according to claim 44, wherein the optical transmitter is configured to control the wavefront predistortion of the optical uplink communications beam on an ongoing basis, based on being configured to detect the wavefront distortions of the optical downlink reference beam via an included wavefront sensor, determine complementary wavefront predistortions for application to the optical uplink communications beam, and apply the complementary wavefront predistortions to the optical uplink communications beam via adaptive optics in the optical transmitter.

46. The terrestrial terminal according to claim 45, wherein the adaptive optics comprise a deformable mirror.

47. The terrestrial terminal according to claim 44, wherein the one or more optical receivers comprise an optical receiver having a first optical path for processing the optical downlink communications beam and a second optical path for processing the optical downlink reference beam.

48. The terrestrial terminal according to claim 47, wherein the optical downlink communications beam and the optical downlink reference beam are at different wavelengths, and wherein the optical receiver includes a filter to direct the optical downlink communications beam into the first optical path and direct the optical downlink reference beam into the second optical path.

49. The terrestrial terminal according to claim 47, wherein the one or more optical receivers are configured to distinguish the optical downlink reference beam from the optical downlink communications beam, based on the optical downlink reference beam being modulated at a specific rate.

50. The terrestrial terminal according to claim 44, wherein the one or more optical receivers comprise respective optical receivers for reception of the optical downlink communications beam and the optical downlink reference beam.

51. The terrestrial terminal according to claim 44, wherein the defined distance by which the beacon satellite leads the communications satellite corresponds with a point ahead angle used by the terrestrial terminal for transmission of the optical uplink communications beam.

52. The terrestrial terminal according to claim 44, wherein the wavefront distortions detected in the optical downlink reference beam correspond to an optical uplink path defined by the point ahead angle.

53. The terrestrial terminal according to claim 44, wherein the terrestrial terminal is a satellite access node (SAN) of the satellite communications system, the optical downlink communications beam is an optical feeder downlink signal, and the optical uplink communications beam is an optical feeder uplink signal.

54. A satellite communications system comprising:
a communications satellite; and
a beacon satellite;
wherein the communications satellite is configured to transmit an optical downlink communications beam from the communications satellite towards a terrestrial terminal and simultaneously transmit an optical downlink reference beam towards the beacon satellite flying ahead of the communication satellite along a same orbital path by a defined distance; and
wherein the beacon satellite is configured to redirect the optical downlink reference beam from the beacon satellite towards the terrestrial terminal, for use by the terrestrial terminal in determining wavefront predistortions applied by the terrestrial terminal to an optical uplink communications beam transmitted by the terrestrial terminal for the communications satellite.

55. The satellite communications system according to claim 54, wherein, when the beacon satellite and communications satellite are in orbit, the defined distance by which the beacon satellite leads the communications satellite corresponds with a point ahead angle used by the terrestrial terminal for transmission of the optical uplink communications beam.

56. The satellite communications system according to claim 54, further comprising the terrestrial terminal, and wherein the terrestrial terminal is configured to:
receive the optical downlink communications beam and the optical downlink reference beam at the terrestrial terminal; and
control wavefront predistortion of an optical uplink communications beam transmitted by the terrestrial terminal for the communications satellite, as a function of wavefront distortions detected in the optical downlink reference beam.
